(19) United States
(12) Patent Application Publication
(10) Pub. No.: US 2010/0275513 A1
(43) Pub. Date: Nov. 4, 2010

(54) AERIAL VEGETATION COVER ARCHITECTONIC SYSTEM

(76) Inventor: Paulo Andre De Miranda Macdowell, Sao Paulo (BR)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/377,415

(22) PCT Filed: Aug. 13, 2007
(86) PCT No.: PCT/BR07/00208

§ 371 Date: Feb. 13, 2009

(30) Foreign Application Priority Data
Aug. 15, 2006 (BR) PI0603480-2

(51) Int. Cl. A01G 9/02; A01G 1/00

(52) U.S. Cl. 47/79; 47/65.5

(57) ABSTRACT

The present invention relates to an aerial vegetation cover architectonic system (1) comprising one column (2), one vase (3), arms (4) and tie rods (5). The vase (3) comprises, inside itself, a substrate and fertilizer for plants and vegetables cultivation, which, when grown, will cover the system arms and tie rods (1).

Descriptive report of patent of invention for “AERIAL VEGETATION COVER ARCHITECTONIC SYSTEM”

The present patent relates to an aerial vegetation cover architectonic system using plants for covering architectonic spaces and urban landscape.

### DESCRIPTION OF THE PRIOR ART

Uncovered parking lots in commercial establishments and shops cause intense insolation on parked vehicles, making customers feel sick when they return to their vehicles, whose internal temperature is high.

Also, concrete-made covers, for example, cause temperature to increase in the lower cover part.

Additionally, building covers are also exposed to sun on a continuous basis, causing discomfort in the following floors.

Covers currently found in the market also have no visual and ecological appeal either, which are essential requirements for marketing a product in the current days.

And also, big environmental problems in urban and rural areas are directly connected to man-nature relationship.

It is very difficult for the modern man to deal with nature and the benefits it can provide, and he ends up destroying it.

The countryside is more and more away and that causes man to get increasingly far from nature.

### BRIEF DESCRIPTION OF THE DRAWINGS

FIG. 1 is a perspective view of the system object of the present application;

FIG. 2 is a first example of use for the system object of the present application;

FIG. 3 shows examples of fitting for the system object of the present application;

FIGS. 4 and 5 are diagrammatic figures for installation of the system object of the present application;

FIG. 6 is a second example of use for the system object of the present application;

FIGS. 7 and 8 are a second embodiment of the system object of the present application;

FIGS. 9, 10, 11, 12, 13, 14,15, 16 and 17 are examples of use for the system object of the present application; and

FIG. 18 is an example of installation and mobility for the system object of the present application.

### DETAILED DESCRIPTION OF THE DRAWINGS

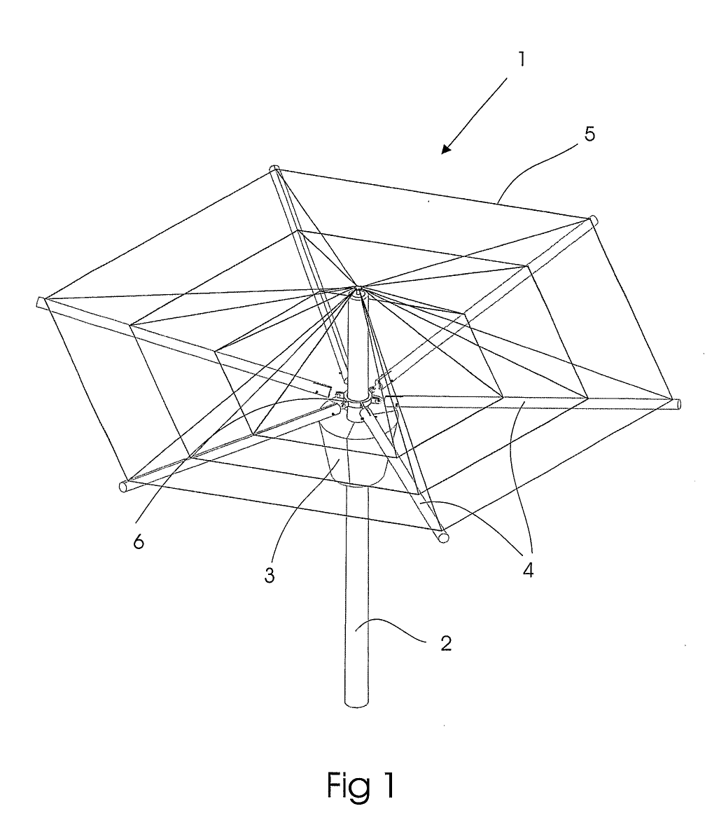

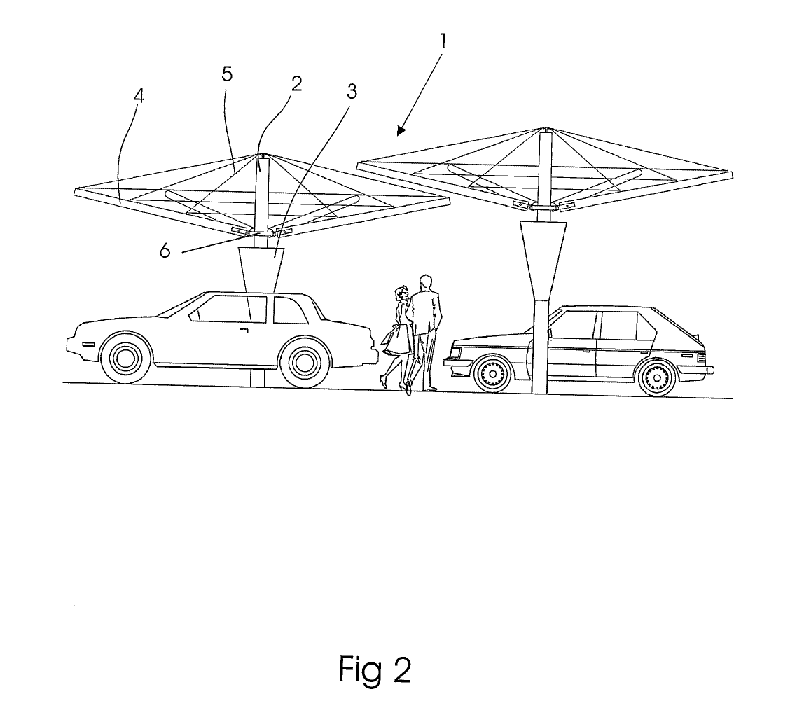

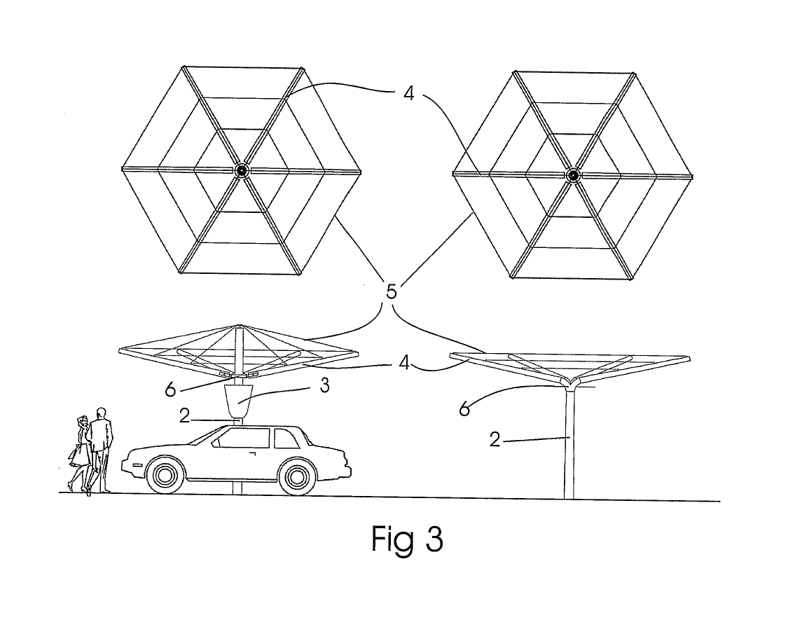

As it can be observed from FIG. 1, a system 1, equipped with a column 2, a vase 3, arms 4 and tie rods 5.

Vase 3 has side orifices (not shown), whose function is to allow vase 3 to be fixed to column 2.

Above vase 3 is provided a fitting means 6 with the function of receiving arms 4. Fitting means 6 may be a ring, connection or any other, as long as it meets the teachings in the present invention.

Tie rods 5 are preferably made of steel, but they may be made of any material, as long as it meets the requirements in the present invention. Such tie rods 5 extend from one arm 4 to another, as well as they may extend from column 2 upper portion to any point in arm 4.

Arms 4 may also be provided with orifices (not shown) and internal plumbing to allow plants irrigation, as it will be further explained.

Vase 3 comprises, in its inner portion, a substrate and fertilizer for plants and vegetables cultivation, which, when grown, will cover system 1 arms and tie rods. Such substrate is watered by the dripping provided from arms 4 orifices, as it has already been afore mentioned, by means of an internal piping, or even by means of conventional hoses.

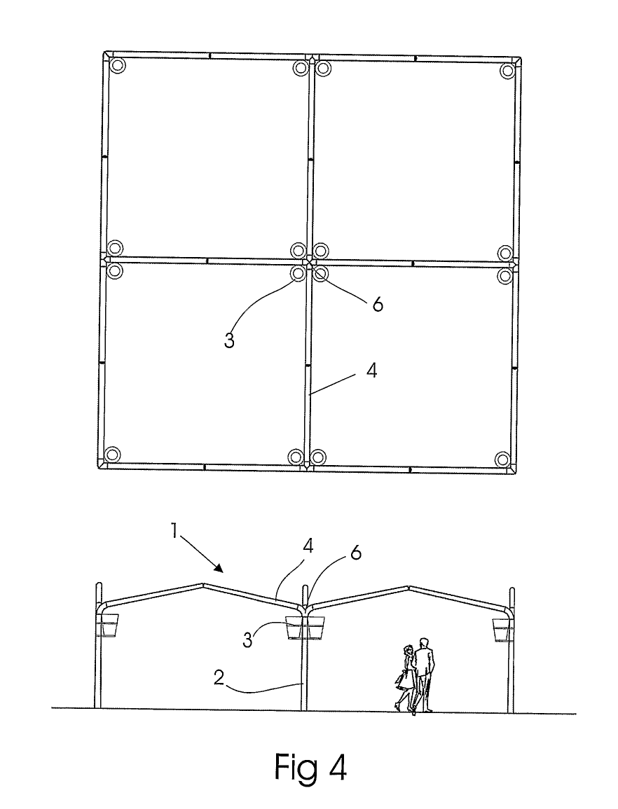

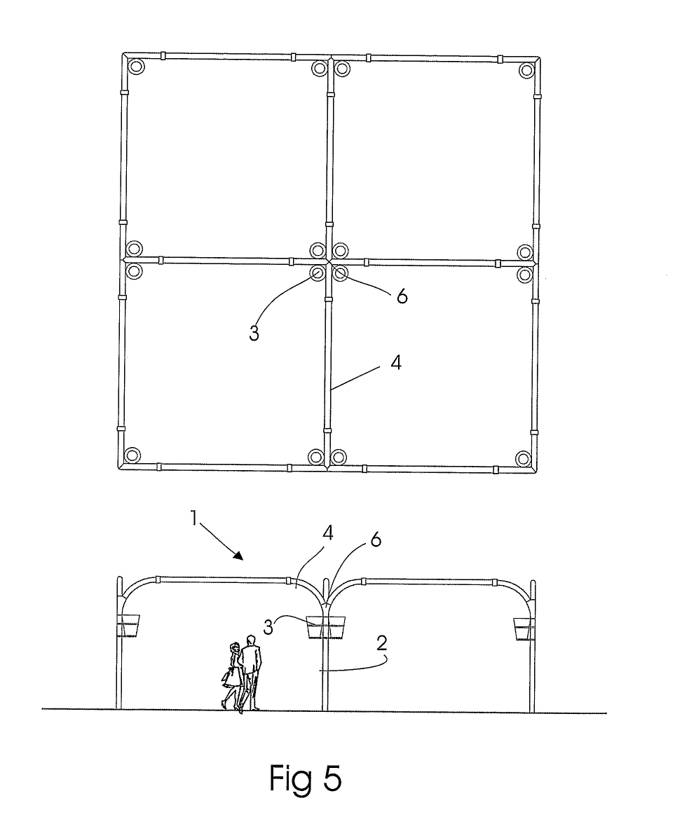

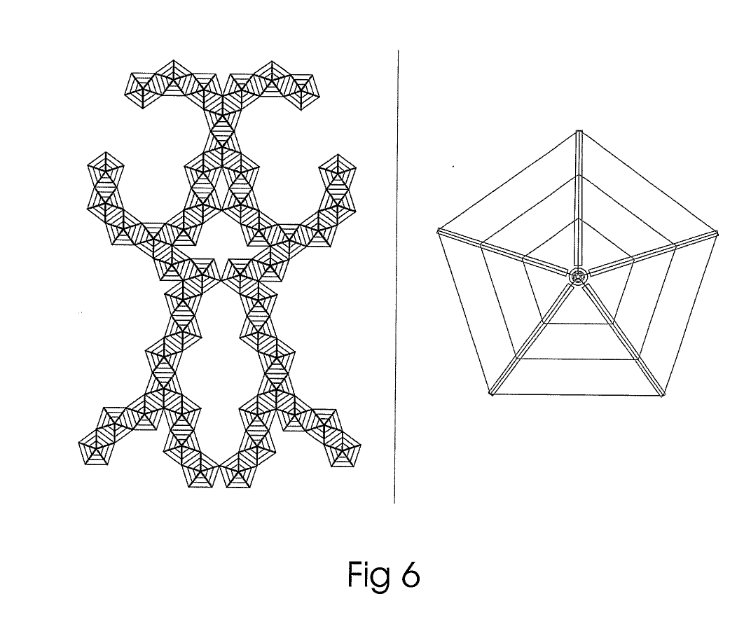

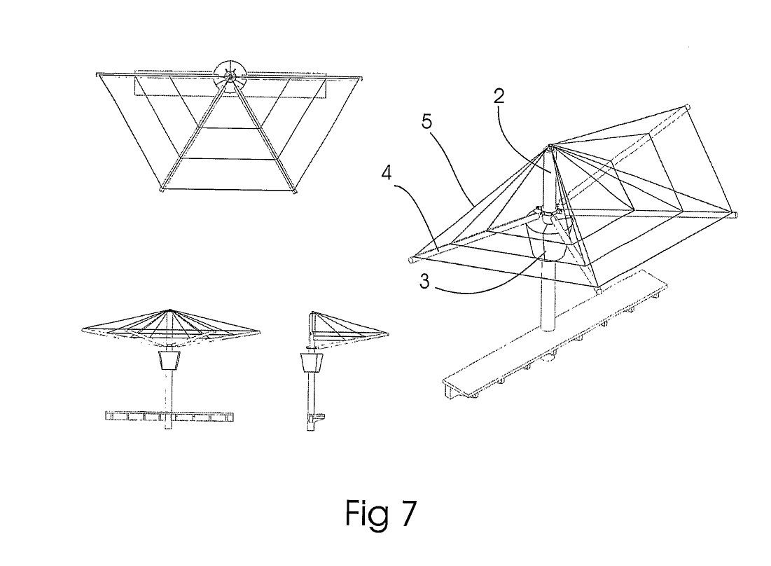

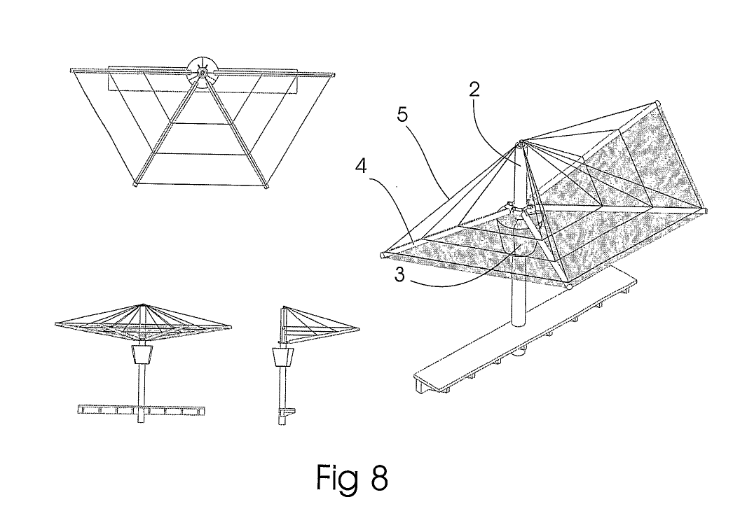

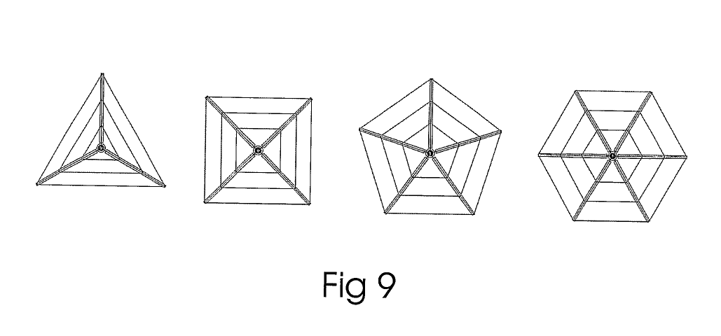

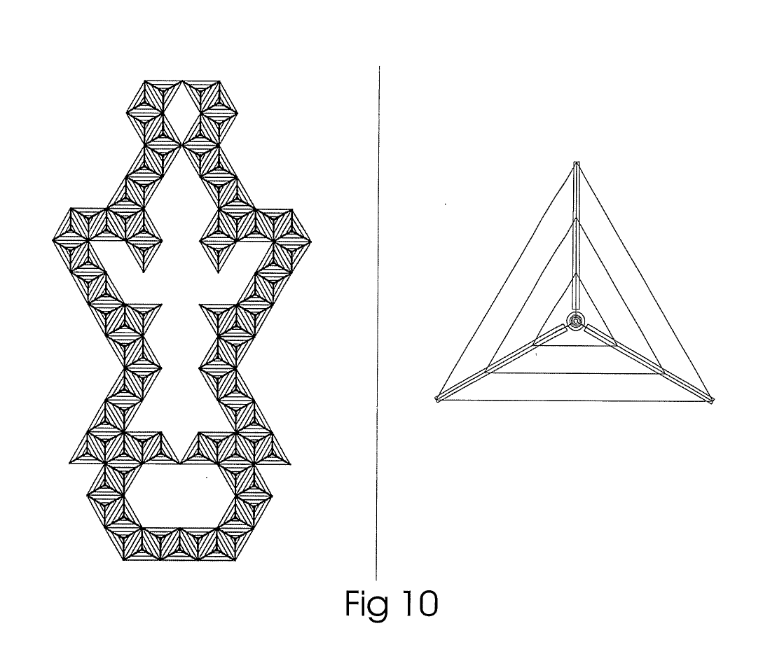

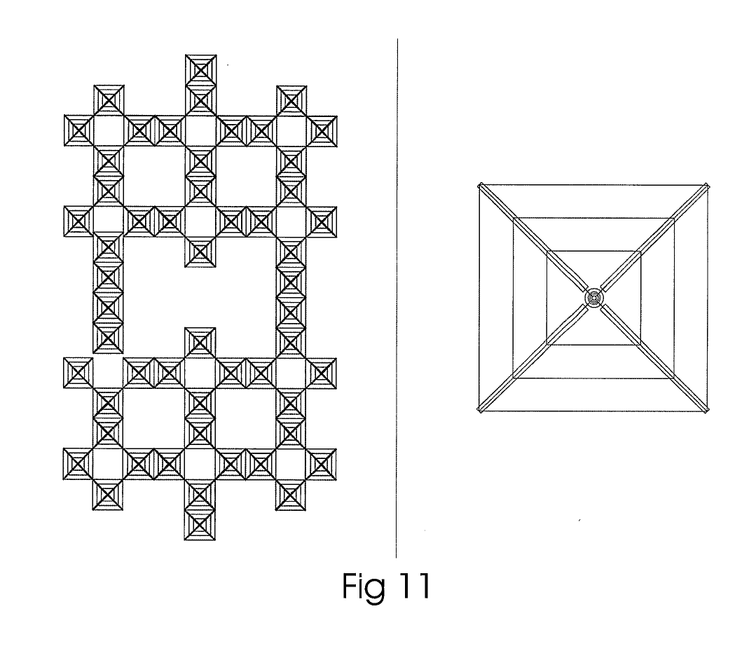

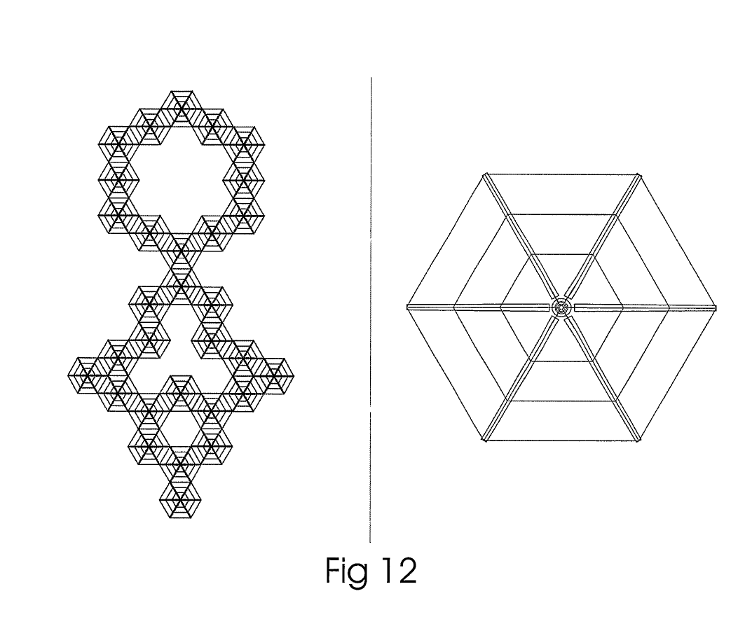

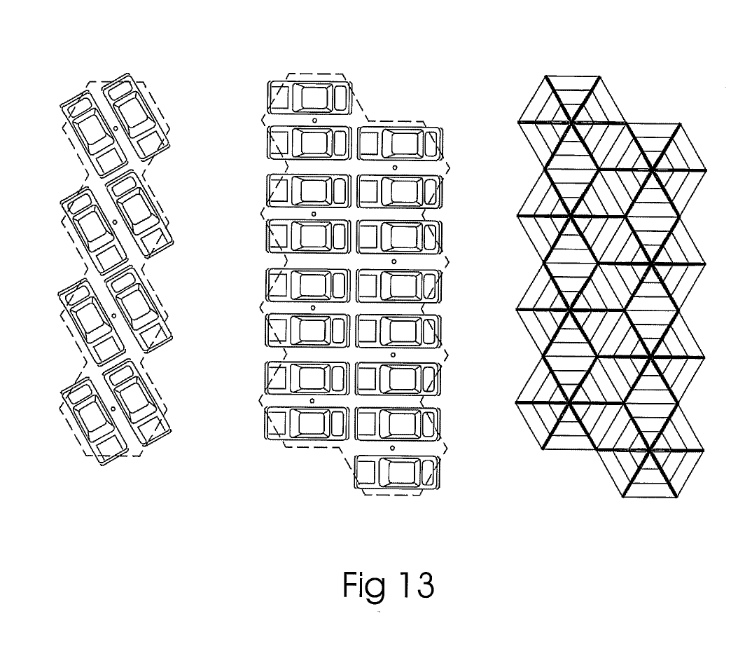

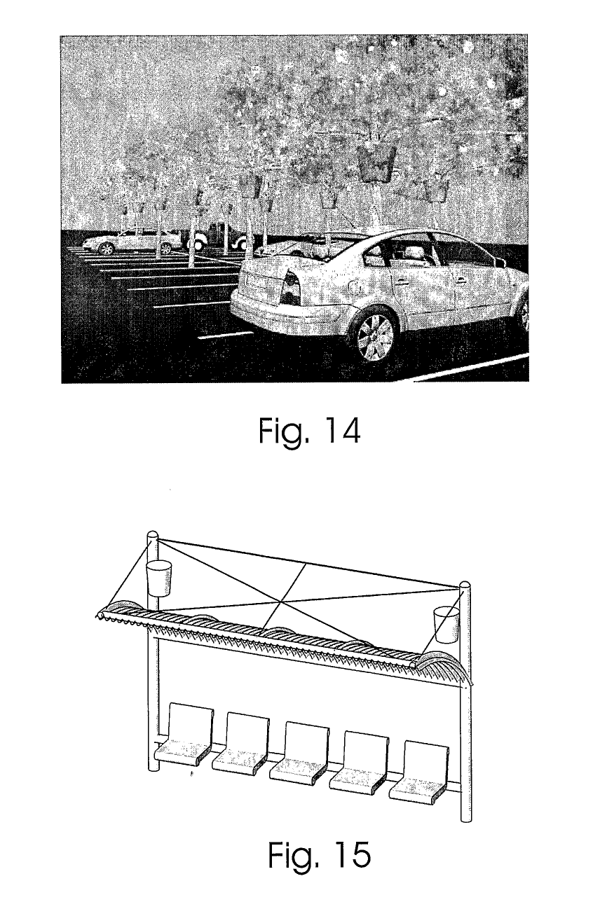

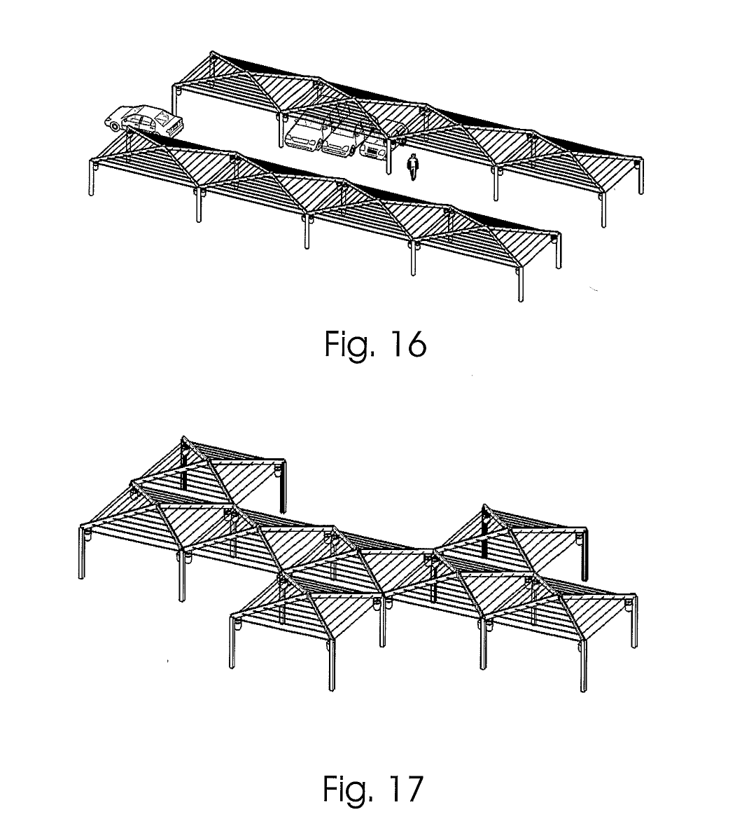

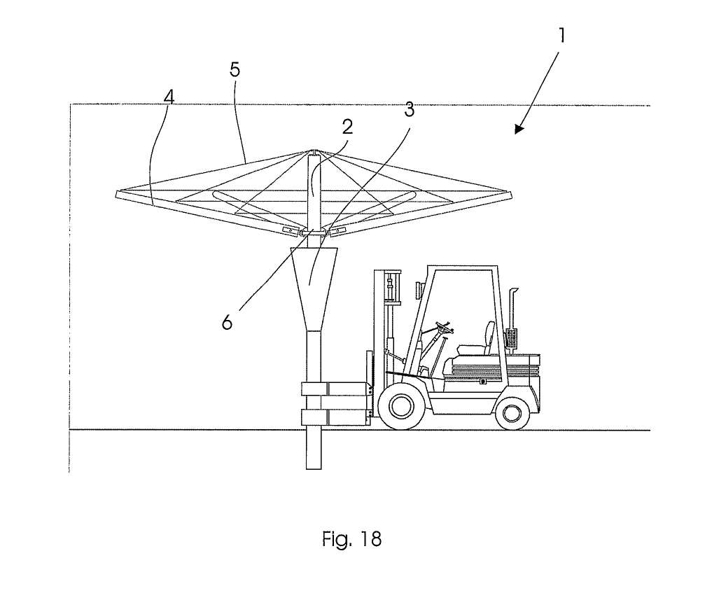

Arms 4 allow several systems 1 to connect to each other, forming, thus, a large cover, as it can be seen from FIG. 4.

System 1 has countless advantages, as described as follows:

System 1 may be used over another already built cover with low implementation cost, on conventional roofs, on the upper slab of buildings, on public platforms, elevated roads, viaducts, bridges, among other architectonic works.

And it can be even a single cover for public spaces, such as parking lots, promenades, squares, public transportation stops and terraces.

System 1 also allows shading of large areas in a more organic and ecological way, and in the least time span, providing, within months, the shading a tree would take over ten years to offer, and creating a useful and versatile landscape, also expanding vegetal cover in urban areas.

Additionally, system 1 object of the present invention increases quality of life, rescuing contact with nature by bringing agricultural production to the urban environment, and making the urban man relive nature by means of cultivation processes.

System 1 provides higher thermal comfort, as well as reduced power consumption on air conditioning in internal areas in the last floor in buildings suffering intense heating from accumulated heat on the slab and roofs; and when used over other roofs and slabs covers, it provides longer durability, by protecting from bad weather conditions, reducing rain impact and insolation on conventional cover.

And also, vases 3 for placing organic substrates for plantation may be made of several materials, such as ceramics, plastic buckets, fiberglass, and in several formats, from the use of conventional buckets to the use of sets of two or three vases 3 involving column 1.

And also, it provides easy mobility, by allowing displacement and repositioning of system 1, even when the vegetal cover is placed, and creating countless dynamic landscape possibilities, being very appropriate for use in hotels, parks and squares, as it can be seen on FIG. 15.

Additionally, it allows air cleaning and substantial improvement of air quality in urban centers, as climbing plants are effective sequesters of carbon gas.

Obviously, it will be noticed that while the above described is to be taken as an illustrative example of this invention, all the other changes and variations made to this invention, in the format that would be apparent to the skilled in the art, are considered within the wide scope and range of this invention, as it is claimed below.

1. “AERIAL VEGETATION COVER ARCHITECTONIC SYSTEM”, characterized in that it comprises one column (2), one vase (3), arms (4) and tie rods (5);
the vase (3), fixed on column (2) by means of lateral orifices;
above the vase (3), a fitting means (6) is provided, with the function of receiving arms (4);
tie rods (5) extend from one arm (4) to the other; and
the vase (3) comprises, inside itself, a substrate and fertilizer for plants and vegetables cultivation, which, when grown, will cover the system arms and tie rods (1).

2. “AERIAL VEGETATION COVER ARCHITECTONIC SYSTEM” according to claim 1, characterized in that the fitting means (6) is a ring.

3. “AERIAL VEGETATION COVER ARCHITECTONIC SYSTEM” according to claim 1, characterized in that the fitting means (6) is a connection.

4. “AERIAL VEGETATION COVER ARCHITECTONIC SYSTEM” according to claim 1, characterized in that the tie rods (5) extend from the upper portion of the column (2) up to any point in arm 4.

5. “AERIAL VEGETATION COVER ARCHITECTONIC SYSTEM” according to claim 4, characterized in that the arms (4) are also provided with orifices and internal plumbing to allow plants irrigation.

6. “AERIAL VEGETATION COVER ARCHITECTONIC SYSTEM” according to claim 5, characterized in that the arms (4) are also provided with a supporting function for a rigid or flexible cover under the vegetation cover, enhancing the covering function for raining conditions.
